(19) United States
(12) Patent Application Publication
(10) Pub. No.: US 2008/0238338 A1
(43) Pub. Date: Oct. 2, 2008

(54) Method and system for providing scalable and configurable illumination

(76) Inventors: Stephen Andrew Latham, Kalamazoo, MI (US); Robert William Tait, Brighton, MI (US); Stephen Johnson Lomnes, Philadelphia, PA (US); Duncan Spalding Pratt, Rexford, NY (US); Carl Stephen Lester, Porter Corners, NY (US)

Correspondence Address: GENERAL ELECTRIC COMPANY (PCPI);C/O FLETCHER YODER, P. O. BOX 692289, HOUSTON, TX, 77269-2289, US

(21) Appl. No.: 11/731,613

(22) Filed: Mar. 30, 2007

(51) Int. Cl. H05B 37/02; F21V 21/00; F21V 9/00

(52) U.S. Cl. 315/294; 362/231; 362/249

(57) ABSTRACT

A modular, scalable and configurable incoherent light source is provided. The light source includes an array of lighting modules supported on a frame that focuses emitted radiation from the modules at a region of interest. The geometry and physical configuration of the support structures, including the frame, may accommodate various energy intensities at various distances. The modules may be made up of multiple LEDs or other individual light sources, may be of different or the same wavelength, and may be individually controllable for the ultimate lighting application. The light source may be used in medical imaging applications.

### BACKGROUND

The present invention relates generally to the field of lighting sources, particularly bright or high power density sources for applications such as medical imaging, and so forth.

Many applications are known for high power density light sources. Depending upon the particular wavelength desired, light sources may take a number of forms, from conventional light bulbs, to laser light sources, X-ray light sources, and so forth. Within the visible spectrum, light source power density is often limited by the physics of the light source and a reflective or focusing mechanism can be used to concentrate their energy. For example, light bulbs of various types are often associated with reflective surfaces and or reflective lamps that focus their energy in a region of interest. For many light sources, particularly for area lighting, a more diffused emission is desired. However, for high intensity applications new techniques are needed for improved light sources that can provide much higher energy densities at a desired distance from the light source.

In one presently contemplated medical application, for example, light is focused on an area of a patient in which a dye or other light absorbing and emitting is injected. The light source must be of very high energy density to enhance the emissions by the tissues, and thereby to improve imaging based upon received (returned) radiation. However, current light sources used in such applications may be one limiting factor on the practicality of the imaging modality, or the quality of the images that can be obtained. Improved lighting sources for these and other applications are therefore needed. Such lighting sources may be used in a variety of other applications, however, including for localized heating, localized bright illumination for various technical, medical, inspection and other applications, and so forth.

### BRIEF DESCRIPTION

The present invention provides an improved light source designed to respond to such needs. The light source may be used in a wide range of applications, particularly where high energy intensities are desired in relatively narrow or reduced areas. The technique is particularly well suited, for example, to medical imaging applications. In general, the invention provides a modular, scalable and configurable incoherent light source.

In accordance with certain aspects of the invention, the light source includes an array of lighting modules, with each module comprising a plurality of light emitting diodes. The array is physically formed to focus light emitted by each of the modules in a desired direction. The geometry of the overall structure, particularly of the array, then, focuses energy from the modules and from the individual light sources (e.g., LEDs).

The array may include support circuitry; particularly interface circuitry for powering the LEDs, driver circuitry for providing such power, and control circuitry. The overall device may also include cooling mechanisms, such as water cooling arrangements, cold plates, and so forth.

The improved light source may be incorporated into a range of systems, including medical imaging systems. When so incorporated, resulting device may be positioned on an adjustable stand or support structure and associated with other components for capturing returned light from a subject for imaging purposes. The array and support structures themselves may be particularly adapted for such application, so as to facilitate the capture of returned light for imaging.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of a light source and supporting circuitry in accordance with aspects of the present invention;

FIG. 2 is a diagrammatical representation of how the arrangement of FIG. 1 focuses light from modules in an array towards an illuminated region;

FIG. 3 is a diagrammatical representation of certain of the geometry of the light source in a focused illumination application;

FIG. 4 is a perspective view an exemplary module for use in the array of the proceeding figures;

FIG. 5 is an exploded diagrammatical representation of certain of the physical and functional components of the light source of the present invention in accordance with an exemplary embodiment;

FIG. 6 is a physical representation of certain of the functional circuit boards in a presently contemplated embodiment broken out to indicate their placement on a support;

FIG. 7 is a diagrammatical perspective view of an exemplary imaging device incorporating a light source in accordance with the invention;

FIG. 8 is an exemplary medical imaging application utilizing the arrangement of FIG. 7;

FIG. 9 is a perspective view of an exemplary installation wherein the light source, and associated imaging components are supported for ease of movement above a subject; and

FIG. 10 is a top view of the arrangement of FIG. 9 illustrating how the light source and other components may be moved over a subject.

### DETAILED DESCRIPTION

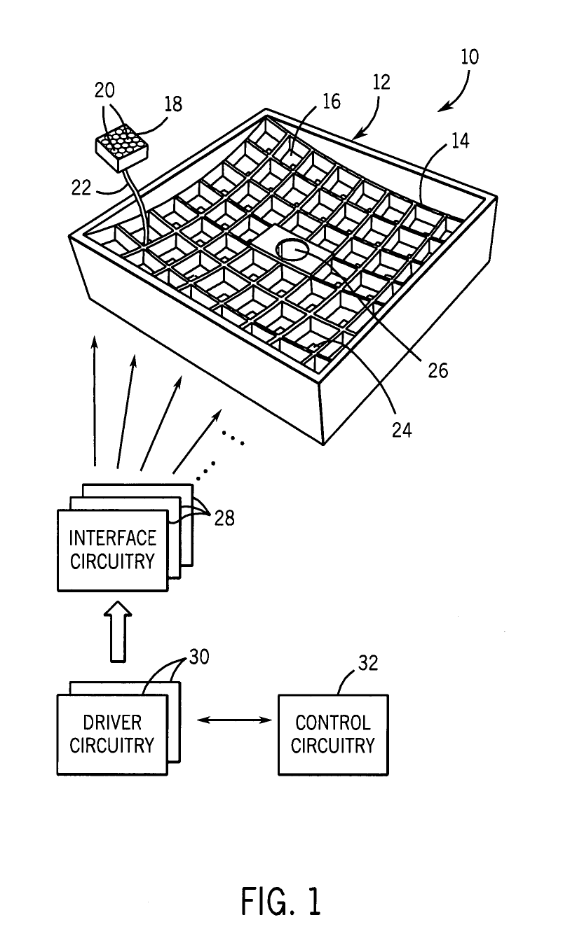

Turning to the drawings, and referring first to FIG. 1, a light source 10 is illustrated generally, along with the associated circuitry for controlling its operation. The light source is made up of the housing 12 in which a frame 14 is disposed. The housing may be made of any suitable material, such as metal (e.g., aluminum), or a moldable plastic. The frame 14 fits within the housing and is formed to focus light radiation from the light source as described more fully below. In the illustrated embodiment, the frame 14 defines an array of receptacles 16, each of which is designed to accommodate a lighting module, one of which is illustrated in FIG. 1, and designated by the reference numeral 18. As described more fully below, each module may be made up of a plurality of lights, particularly of commercially available LEDs arranged in a tight pattern, as designated in FIG. 1 by reference numeral 20. Each module is supplied with power for illuminating the LEDs by means of a cable 22. Passages 24 are provided in the base of each receptacle for allowing the cable to exit the receptacle and join power and control circuitry as described below.

In general, the light source described herein provides a diffuse illuminator that utilizes commercial available LED packages of any suitable wavelength or form factor. The design incorporates a modularized surface that can focus all sources at desired focal points. As described below, the light source may also incorporate fixtures needed for filtering light as well as various techniques for fixturing the LEDs and other components. The LEDs themselves, depending upon the application, may be of various colors and wavelengths, with multiple LEDs being provided, where desired, for specialized applications, such as medical imaging applications described below. The light source is thus a high power illuminator with high concentration of power in a set region of interest, tunable to any wavelength or combination of wavelengths. The light can be switched at low frequencies or intensity modulated at very high frequencies.

In the presently contemplated embodiment illustrated in FIG. 1, for example, the array of lighting modules includes seven modules in the first direction and eight modules in a second direction. The number, size and placement of these in the array, however, can be changed to allow for selection of a variety of discreet units, assembly of modular, scalable and configurable light sources, and for focusing the emitted radiation in relatively confined or more diffuse areas. For example, if a certain wavelength of light is needed at high power, the source can be populated with one type of module. If two wavelengths are required, two types of modules may be selected, and so forth. The intensity of the modules may be selected to achieve high power as would otherwise be provided at only one wavelength. Other illumination modules, such as laser diodes may also be used, where desired.

To support the modules in operation, various electrical circuitry is contemplated. In the diagrammatical representation of FIG. 1, for example, interface circuitry 28 allows for connections between the various modules and driver circuitry 30. In presently contemplated embodiments, for example, an interface circuit board of the circuitry 28 is provided for each individual module, with LEDs of that module connected in series. In the same presently contemplated embodiment, driver circuitry 30 comprises two driver boards that supply power to the interface circuitry, which then routes the power to the modules. Both the interface circuitry and the driver circuitry may permit for individually addressing modules, such as to selectively illuminate only certain modules. This may be particularly desirable where specific areas are to be illuminated, intensities are to be chosen, or specific wavelengths to be chosen for individual applications or during certain periods of use. Control circuitry 32 is coupled to the driver circuitry to allow for such control, to switch on power to one or more modules, and so forth. The circuitry is, of course, not limited to that represented in this or other figures, and particular circuits may be adapted to permit any desired control, addressing or modules, modulation of output intensity, and so forth.

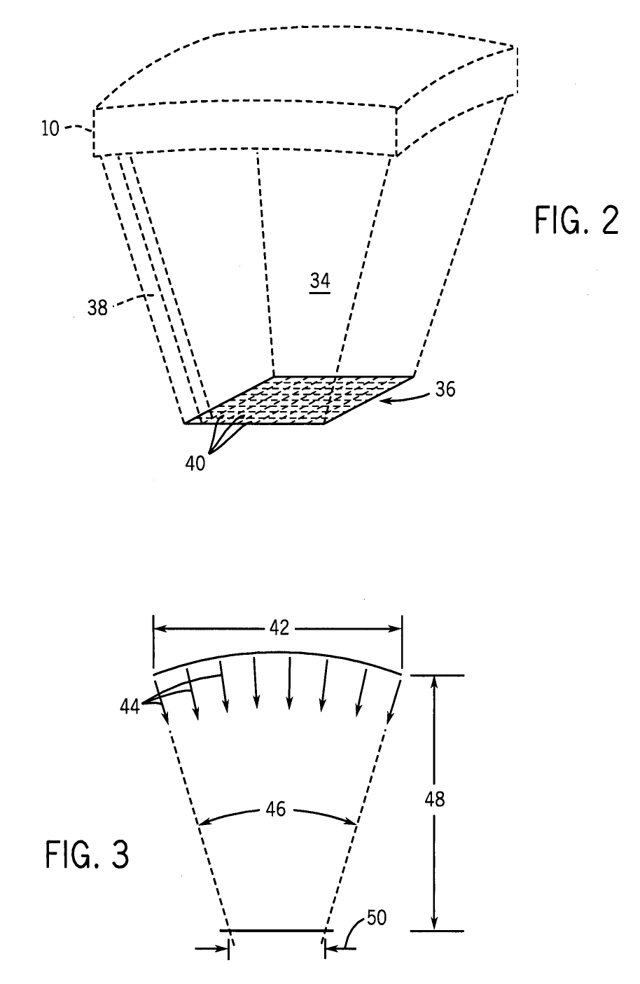

The radiation emitted by the various modules may be focused by virtue of the geometry of the array defined by the housing and frame shown in FIG. 1, as generally illustrated in FIG. 2. As shown in FIG. 2, the light source 10, by virtue of its geometry, will focus radiation, designated generally by reference numeral 34, towards an illuminated region 36. In particular, each of the modules illustrated in FIG. 1 will direct a beam of radiation, one of which is illustrated in FIG. 2 and indicated by reference numeral 38, towards individual areas 40 within the illuminated region 36. The regions may overlap, or may be separate from one another, depending upon the geometry of the array and the desired distance that the illuminated region 36 lies from the array. It should be noted that the particular pattern of illumination need not be rectangular, as generally illustrated in FIG. 2. In a presently contemplated embodiment, for example, each LED forms a generally semi-circular spot of illumination. The overall effect, in this same embodiment, is that the illuminated field is generally circular, having a diameter of approximately 12 cm at a distance of approximately 50 cm from the light source.

Such geometry is illustrated generally in FIG. 3. In particular, the light source may be considered to have a width 42 in the direction illustrated in FIG. 3 such that beams of converging radiation 34 are emitted. The illuminated region, then, receives the converging radiation at an overall angle of conversion, as indicated by reference numeral 46 in FIG. 3. In reality, one or more angles of convergence may be similarly represented between the individual beams emitted by the modules. This angle need not be the same between adjacent modules in the array, or, conversely, the individual angles may be identical so as to converge at a constant rate along the array. The individual angles of convergence can be defined by the frame itself, by the position of the modules in the frame, or even by the position of individual light sources within the modules. Based upon the angle of conversion and the width of the light source, then, at a desired distance 48 from the light source, a region of width 50 will be illuminated. As will be appreciated by those skilled in the art, the diagram of FIG. 3 shows the convergence of the radiation in one dimension only, while in general the radiation may converge in two dimensions, or in various patterns so as to provide the desired intensity across the region of interest.

In a presently contemplated embodiment, for example, the light source has dimensions of approximately 25×30 cm, and provides converging radiation so as to focus radiation on an area of approximately 12×12 cm² at a distance of approximately 50 cm. The same arrangement provides an energy density at the illuminated surface of approximately 60 mW/cm².

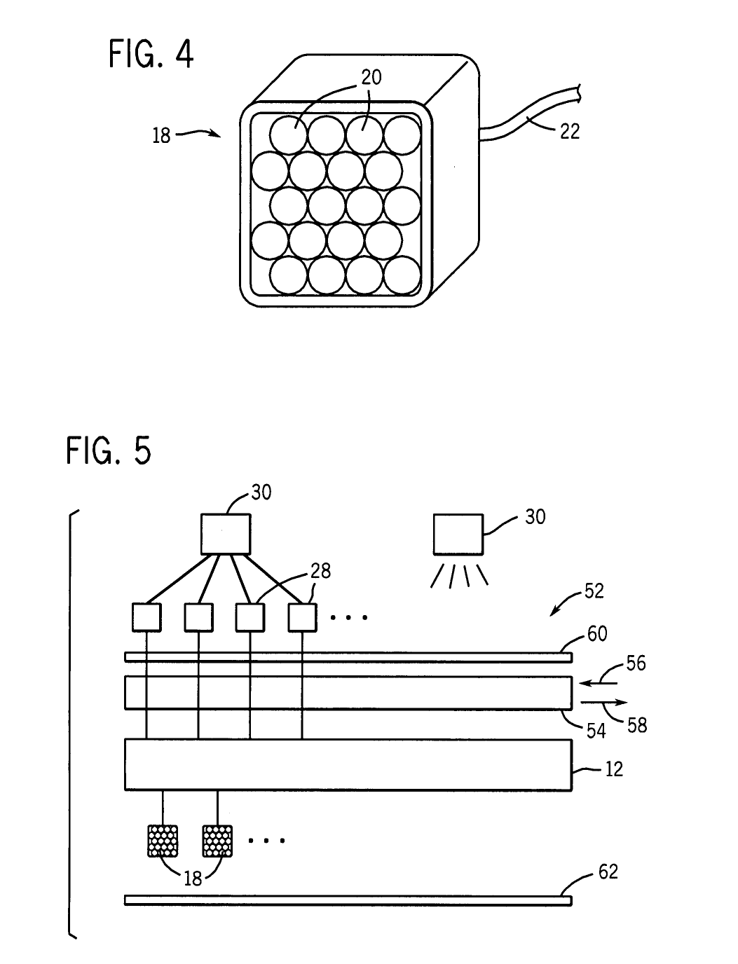

FIG. 4 illustrates an exemplary module 18 for use in the light source described above in accordance with a presently contemplated embodiment. As illustrated, the module is, itself, formed of a frame or shell designed to accommodate a series of individual lighting devices, LEDs 20 in this case. Each of the LEDs is coupled to the power supply cable 22, and, in the present embodiment, these were coupled in series. It may also be noted that in the present embodiment illustrated, 20 LEDs are provided in each module, arranged in closely packed rows.

FIG. 5 illustrates certain of the physical and functional components in an exploded view. As described above, the light source itself is designed around a housing 12 in which a frame (not represented in FIG. 5) is positioned. Individual lighting modules 18 are disposed in the housing 12 and are coupled to interface circuitry 28 which, itself, receives power from driver circuitry 30. The assembly, designated generally by reference numeral 52, may further include a cooling device, such as a cold plate 54 illustrated in FIG. 5. The cold plate, which may be made of any suitable material, such as aluminum, may be designed to absorb heat from the individual modules, and to radiate, or otherwise conduct heat from the assembly. In the presently contemplated embodiment illustrated, the cold plate 54 receives a circulation of cooling fluid, such as water, through an inlet 56 and, after circulation, expels heated water through an outlet 58. The cold plate 54, nevertheless, provides for passage or is otherwise constructed to allow cabling to be extended between the interface circuitry 28 and individual modules 18. The cold plate may be associated with manual or automatic valving, pumps, and so forth (not shown) to allow for the circulation of cooling fluid to be controlled.

The assembly 52 may also include a support 60 used for mounting the individual circuit boards defining the interface circuitry 28 and the driver circuitry 30, as well as any other circuitry, sensors, feedback devices, and so forth. Finally, the assembly may include one or more filters 62 for adjusting the output wavelength of the light sources to a desired spectrum, where desired.

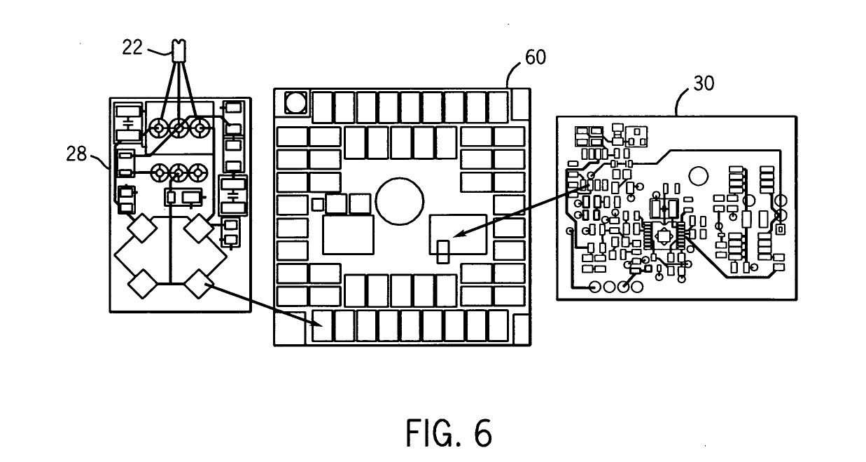

FIG. 6 illustrates a presently contemplated arrangement of the interface and driver circuitry discussed above. As noted above, the light source may include one or more supports, such as a connection board 60 illustrated in FIG. 6 designed to fit behind the frame discussed above that houses the modules. The individual interface circuitry is populated on interface boards 28, with one interface board being provided for each module in the presently contemplated embodiment. These boards are supported on the connection board 60, along with driver circuit boards 30. The driver boards, in the presently contemplated embodiment, are two in number, with each board supplying power to half of the interface boards for the lighting modules.

For certain applications, the light source may be designed and physically configured with features that accommodate the specific application. Referring back to FIG. 1, and as also shown for the connection board in FIG. 6, for a medical imaging application, for example, a central aperture 26 may be formed in the frame. The aperture is designed to permit returned radiation from an imaging application (e.g., a medical or surgical subject) to be returned through the center of the light source.

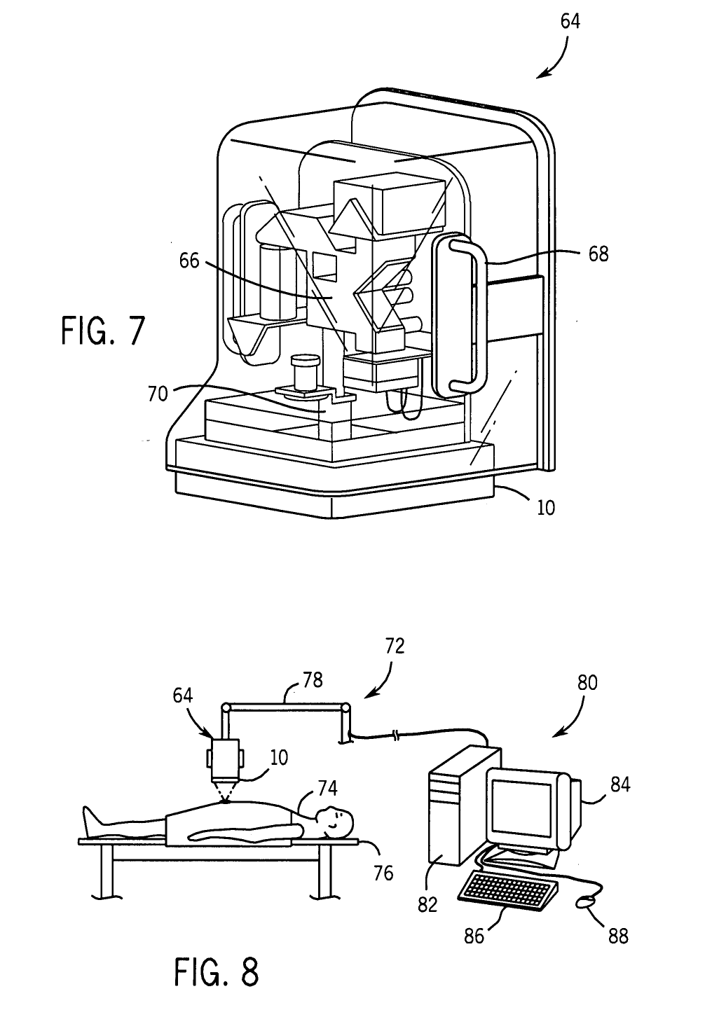

FIG. 7 illustrates an exemplary imaging device that incorporates this arrangement for imaging purposes. The imaging device 64 includes various imaging components, based around the light source 10 and disposed in a frame or housing. In particular, the frame 68 supports the light source 10 along with an optical system 66 that channels returned radiation through a receiver 70 for generating medical images in accordance with generally known techniques. As described below, the imaging device will typically be positioned over a subject and adjusted so that the desired energy density of radiation is provided at the tissue of interest, with returned radiation being used for imaging purposes. In such applications, it may be advantageous to provide two or more different wavelengths of light, and this may be accomplished by selecting appropriate LEDs, modules, or filters that output the desired wavelengths. For example, in certain presently contemplated medical imaging applications, wavelengths in the visible and infrared spectra may be used, along with white lights. Other wavelengths and spectra may, of course, be employed.

FIG. 8 illustrates an exemplary medical imaging application of this type, in which an imaging system 72 employs an imaging device 64 of the type illustrated in FIG. 7. The system 72 is used for generating images of a patient 74 by the use of concentrated incoherent light from the light source 10. In general, the patient may be seated or reclined on a table 76, such as in a surgical suite in surgical applications. The imaging device is positioned above the patient by means of a support structure 78.

As will be appreciated by those skilled in the art, the imaging system 72 operates under the control of a control system designated generally by reference numeral 80 in FIG. 8. The control system will include one or more appropriately programmed special purpose or a general purpose computers 82 designed to carry out imaging sequences by appropriately illuminating the tissue of interest with one or more specific wavelengths of light, receiving returned radiation that is converted to electrical signals, and processing the electrical signals to reconstruct a useful image. The control is facilitated by the use of operator interface devices, such a one or more monitors 84, keypads 86, computer mice or other input devices 88, and so forth.

Again, those skilled in the art will appreciate that the arrangement of FIG. 8 may be employed for clinical imaging, during surgery, and so forth. In a surgical application, for example, real time fluorescent imaging may be performed by illuminating exposed tissues in which fluorescent agents or dyes have been injected. The dyes will typically fluoresce when excited by light at known wavelengths (provided by the light source described above), and will then return radiation that can be detected, converted to corresponding electrical signals (e.g., in an imaging detector or camera), and these signals used to reconstruct images.

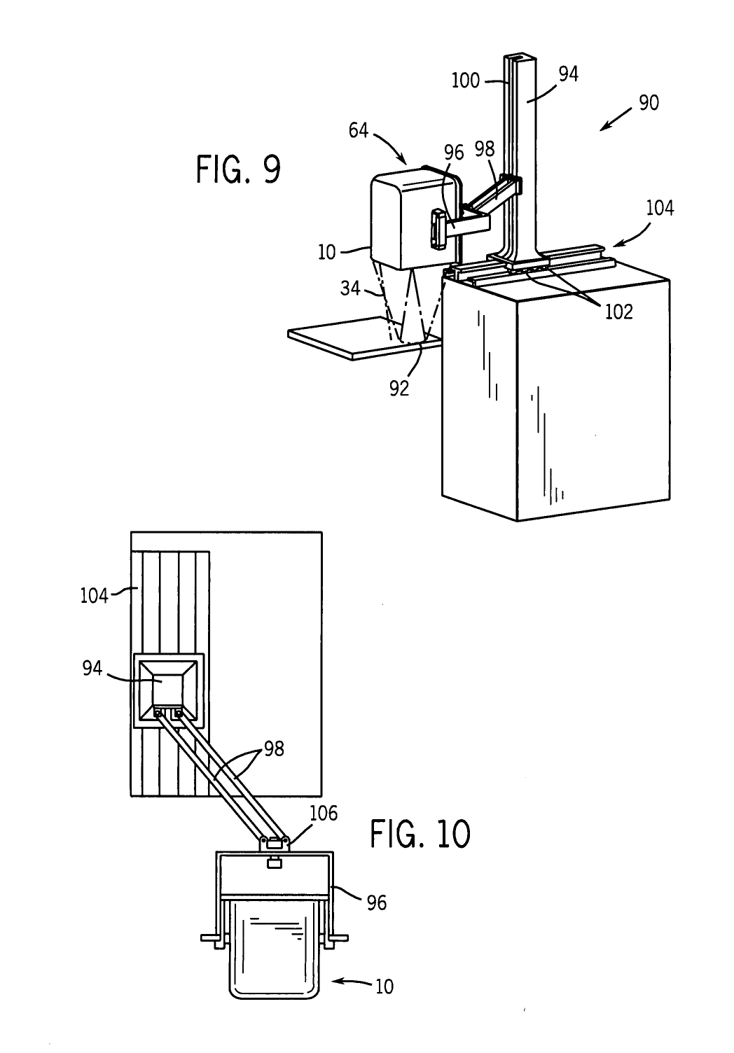

To facilitate appropriate positioning of the light source in a specific application, support structures such as those shown in FIGS. 9 and 10 may be provided. In the arrangement illustrated in FIG. 9, for example, a support structure 90 is provided for an imaging device 64 that incorporates the light source 10 of the invention. As noted above, the light source will be arranged to appropriately focus emitted radiation 34 at a desired distance, at a desired energy density, and at desired wavelengths. Radiation returned from the subject, indicated generally by reference numeral 92, will re-enter the imaging device 64.

The imaging device 64 is supported for ease of positioning above the area to be illuminated. In the illustrated embodiment, the support structure includes a vertical support 94 on which a bracket 96 is attached by means of four-bar linkage device 98. The four-bar linkage may be raised and lowered on the support 94 such as by means of a rail interface 100. A base 102 of the support 94 may, in turn, interface with a longitudinal rail 104 for ease of movement of the entire support. As shown in FIG. 10, the four-bar linkage may attach to a support clevis or bracket structure 106. With pivotal supports at corners of the four-linkage, then, the entire system may be moved in a controlled manner and the imaging device maintained generally oriented as desired over the patient. The structure also allows for ease of movement into the imaging position, and away from the patient to allow for access to the patient, particularly useful in a surgical suite.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A lighting system, comprising:
a plurality of first lighting modules each comprising a plurality of light-emitting diodes operable to emit incoherent light corresponding to a first wavelength;
a plurality of second lighting modules each comprising a plurality of light-emitting diodes operable to emit incoherent light corresponding to a second wavelength different than the first wavelength; and
a frame having a plurality of receptacles configured to receive a lighting modules and to direct radiation from each of the lighting modules toward a desired region.

2. The lighting system of claim 1, wherein the first wavelength is in a visible spectrum.

3. The lighting system of claim 2, wherein the second wavelength is in an infrared spectrum.

4. The lighting system of claim 1, comprising a plurality of third lighting modules having a plurality of light-emitting diodes operable to emit white light.

5. The lighting system of claim 1, wherein each receptacle is adapted to receive any one of the first lighting modules and second lighting modules.

6. The lighting system of claim 1, comprising power supply and control circuitry operable to control light emission from the first lighting module and the second lighting module.

7. The lighting system of claim 1, comprising a detector operable to detect light at a plurality of different wavelengths.

8. The lighting system of claim 1, wherein the lighting modules are capable of producing an energy intensity of at least approximately 60 mW/cm² at a distance of at least approximately 50 cm from the frame.

9. A lighting system, comprising:
a plurality of lighting modules each comprising a individual light sources; and
a frame configured to receive and support the lighting modules and to direct radiation from each of the lighting modules toward a desired region at a defined distance from the frame at an intensity of at least approximately 60 mW/cm² at a distance of at least approximately 50 cm.

10. The lighting system of claim 9, wherein the individual light sources are light emitting diodes arranged in an array.

11. The lighting system of claim 10, wherein the frame is formed to orient the lighting modules to direct the radiation from the plurality of lighting modules in a converging pattern toward the desired region.

12. The lighting system of claim 10, wherein the modules include light emitting diodes configured to emit light of at least two different wavelengths.

13. The lighting system of claim 9, further comprising driver and interface circuitry for powering the individual light sources, the driver and interface circuitry being supported in an common enclosure with the frame.

14. An imaging system comprising:
a light source including a plurality of lighting modules, each lighting module comprising a plurality of light-emitting diodes operable to emit light, a frame having a plurality of receptacles adapted to receive the lighting modules and to direct radiation from the lighting modules toward a desired region of a subject at a defined distance from the frame, and a power supply operable to supply power to the plurality of lighting modules; and
an image device for receiving radiation returned from the subject resulting from irradiation by the light source and for generating imaging signals representative thereof.

15. The imaging system of claim 14, wherein the frame has an aperture formed therein for receiving the radiation returned from the subject.

16. The imaging system of claim 14, wherein the light emitting diodes are configured to emit light at two different wavelengths.

17. The imaging system of claim 16, wherein the light emitting diodes are configured to emit light within a first wavelength in a visible spectrum.

18. The imaging system of claim 16, wherein the light emitting diodes are configured to emit light within a first wavelength in an infrared spectrum.

19. The imaging system of claim 14, comprising power supply and control circuitry operable to control light emission from the lighting modules.

20. The imaging system of claim 14, wherein the lighting modules are capable of producing an energy intensity of at least approximately 60 mW/cm² at a distance of at least approximately 50 cm from the frame.

21. The imaging system of claim 14, wherein the light source and the image device are provided in a common housing supported by a positioning structure that allows the housing to be positioned over a region of interest of the subject.
